(19) United States
(12) Patent Application Publication
(10) Pub. No.: US 2025/0180940 A1
(43) Pub. Date: Jun. 5, 2025

(54) ONBOARD DEVICE

(71) Applicant: PANASONIC AUTOMOTIVE SYSTEMS CO., LTD., Kanagawa (JP)

(72) Inventor: Tosiyuki EBATA, Kanagawa (JP)

(73) Assignee: PANASONIC AUTOMOTIVE SYSTEMS CO., LTD., Kanagawa (JP)

(21) Appl. No.: 18/966,793

(22) Filed: Dec. 3, 2024

(30) Foreign Application Priority Data
Dec. 4, 2023 (JP) 2023-204778

(51) Int. Cl. G02F 1/13

(52) U.S. Cl. CPC G02F 1/1306; G02F 2202/16; G02F 2202/28

(57) ABSTRACT

There is provided an onboard device including: a liquid crystal display; a first metal plate; and a second metal plate, which are arranged in a layer structure. The liquid crystal display and the first metal plate are connected by a conductive adhesive to ensure GND. The first metal plate and the second metal plate are connected by the conductive adhesive to ensure the GND. A fixing adhesive is disposed around the conductive adhesive.

### CROSS-REFERENCE TO RELATED APPLICATIONS

This application is based on and claims priority under 35 USC 119 from Japanese Patent Application No. 2023-204778 filed on Dec. 4, 2023, the contents of which are incorporated herein by reference.

### TECHNICAL FIELD

The present disclosure relates to an onboard device.

### BACKGROUND ART

In the related art, a display device including a liquid crystal display (LCD) is known as an example of an onboard device. Various structures and methods have been proposed for an electronic device in order to satisfy requirements for electromagnetic interference (so-called noise). In general, an onboard device has strict requirements for electromagnetic interference standards. In order to ensure noise performance in response to the requirements, a structure in which ground (GND) is ensured at a plurality of positions for an electronic component mounted in an LCD and the like is essential. However, since many LCDs used in onboard devices cannot be fastened with screws due to their structure, a mainstream structure for ensuring GND is to use an earth spring to bring the LCD into contact with a metal plate portion.

In the structure, deformation, dimensional deviation, and the like of the earth spring occur, which affects the quality of the LCD. Further, according to the shape of the metal plate portion, in a case where it is necessary to ensure GND at a position where the earth spring cannot be disposed or in a case where the GND portion is increased after the metal plate portion is subjected to metal processing, an additional member such as a gasket may be added between the LCD and the metal plate portion. As a result, problems such as deterioration in workability of assembly, an increase in costs such as material costs, and a falling-off risk of the additional member occur.

For example, JP2010-164946A discloses a configuration in which a conductive adhesive is used for earth connection in an image display device.

For example, small unevenness is present on a surface of a metal plate member, which is a component of the onboard device. When conductive tape is attached to the surface of such a member or the conductive adhesive is applied, minute bubbles may enter the uneven portion. In the bubble portion, the metal plate and the conductive adhesive are not in contact with each other. In a case where a metal plate, which is a relay member, is interposed in order to ensure GND, it is assumed that electrical resistance increases due to the influence of the uneven portion and the like, and GND performance deteriorates. Further, when the conductive adhesive is used, peeling, falling-off, and the like of the conductive adhesive may occur due to deformation of the LCD, an external pressure, and the like. As a result, a short circuit caused by a reduction in the GND performance and a fallen object may occur. Therefore, a further improvement is required to ensure and stabilize the GND performance.

### SUMMARY OF INVENTION

The present disclosure provides an onboard device which can ensure and stabilize GND performance in a liquid crystal display included therein.

According to an illustrative aspect of the present disclosure, an onboard device includes: a liquid crystal display; a first metal plate; and a second metal plate, which are arranged in a layer structure. The liquid crystal display and the first metal plate are connected by a conductive adhesive to ensure GND. The first metal plate and the second metal plate are connected by the conductive adhesive to ensure the GND. A fixing adhesive is disposed around the conductive adhesive.

According to the present disclosure, it is possible to ensure and stabilize the GND performance in the liquid crystal display included in the onboard device.

### BRIEF DESCRIPTION OF DRAWINGS

FIG. 1 is an exploded view showing a configuration example of an onboard device according to an embodiment of the present disclosure;

FIG. 2 is a conceptual diagram illustrating a connected state according to the embodiment of the present disclosure;

FIG. 3 is a conceptual diagram illustrating a connected state of a configuration in the related art which is shown as a comparative example;

FIG. 4 is an enlarged view illustrating an uneven portion of a surface of a metal plate;

FIG. 5 is a conceptual diagram illustrating a connected state according to the embodiment of the present disclosure;

FIGS. 6A and 6B are schematic views illustrating arrangement of an adhesive according to the embodiment of the present disclosure; and

FIG. 7 is a conceptual diagram illustrating a configuration example according to another embodiment of the present disclosure.

### DESCRIPTION OF EMBODIMENTS

Hereinafter, embodiments specifically disclosing an onboard device including a liquid crystal display according to the present disclosure will be described in detail with reference to the drawings as appropriate. However, unnecessarily detailed description may be omitted. For example, detailed description of well-known matters and the redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matters described in the claims.

In the following description, expressions “first” and “second” are merely illustrated for convenience to distinguish from other components, and are not intended to be interpreted in a limited manner to specific parts. Accordingly, it is assumed that the expressions can be appropriately read in accordance with the configuration and the like. Further, in the drawings used in the following description, three-dimensional coordinate systems are shown, which correspond to the directions in each drawing. In the three-dimensional coordinate system shown in each drawing, when the liquid crystal display is viewed from the front, an X axis indicates a width direction (left-right direction), a Y axis indicates a height direction, and a Z axis indicates a depth direction.

### Embodiment 1

### (Device Configuration)

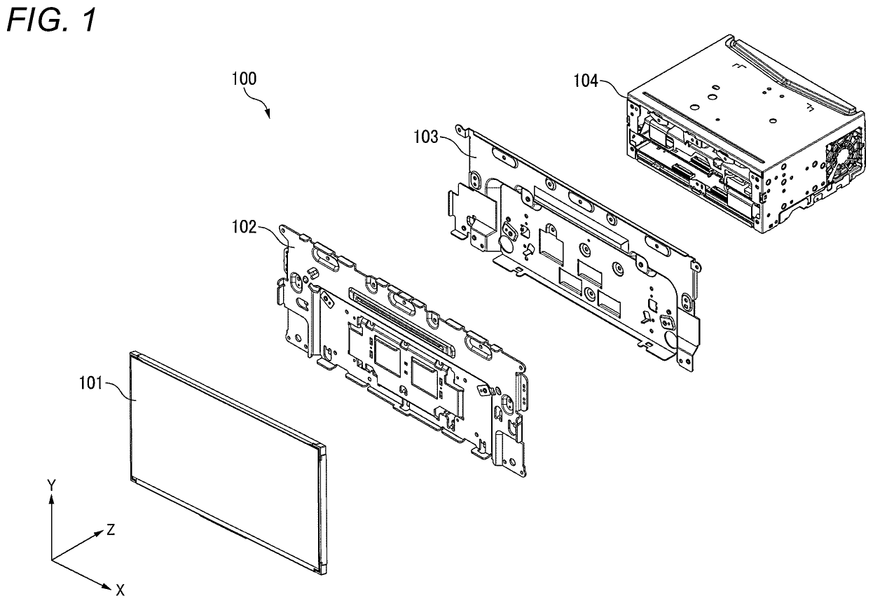

FIG. 1 is an exploded view illustrating an internal configuration of an onboard device 100 according to the present embodiment. In the present embodiment, a description will be given using an onboard device 100 that is mounted on a vehicle (not shown) such as an automobile and includes a liquid crystal display. Generally, an onboard device including a liquid crystal display is disposed at a position that is visually recognized by a driver of the vehicle, but is not limited thereto. FIG. 1 illustrates only components according to the description of the present embodiment. Thus, other components may be provided in the onboard device 100. In particular, the other components may be disposed between the components shown in FIG. 1 as long as the connected state to be described later is not electrically inhibited.

In the present embodiment, the onboard device including the liquid crystal display will be described as an example. For example, it is needless to say that similar effects and functions can be provided by adopting a similar configuration even in other electronic devices that have high requirements for electromagnetic interference, external pressure, and thermal contraction.

The onboard device 100 according to the present embodiment includes a liquid crystal display (hereinafter, referred to as “LCD”) 101, a first metal plate 102, a second metal plate 103, and a housing 104. A user (for example, a driver of a vehicle (not shown)) is positioned on the LCD 101 side and can visually recognize a screen.

The LCD 101 may have a configuration in the related art and will not be described in detail here. In order to ensure noise performance of the onboard device 100, it is necessary to ensure GND by making the electric components of the LCD 101 in communication with the first metal plate 102 and the second metal plate 103.

The first metal plate 102 and the second metal plate 103 are made of a conductive material. The first metal plate 102 and the second metal plate 103 serve to connect or fix each part included in the onboard device 100. The first metal plate 102 and the second metal plate 103 may be made of the same material or different materials.

The housing 104 controls the entire operation of the onboard device 100 such as display control of the LCD 101. The housing 104 may include, for example, a control device, a storage device, a communication device, a sensor, and the like (not shown). The control device (not shown) may be implemented by using, for example, a central processing unit (hereinafter, referred to as “CPU”), a graphical processing unit (hereinafter, referred to as “GPU”), a micro processing unit (hereinafter, referred to as “MPU”), a digital signal processor (hereinafter, referred to as “DSP”), or a field programmable gate array (hereinafter, referred to as “FPGA”). The storage device is a storage unit for storing various data, programs, and the like, and may be implemented by, for example, a volatile and nonvolatile storage device such as a random access memory (hereinafter, referred to as “RAM”), a read only memory (hereinafter, referred to as “ROM”), or a flash memory.

The communication device (not shown) is a part for performing wireless communication with an external terminal, and any communication standard or frequency band such as Wi-Fi (registered trademark) or Bluetooth (registered trademark) may be used in combination. The sensor (not shown) may include a position sensor for acquiring position information of the onboard device 100. The position sensor performs positioning using a global navigation satellite system (hereinafter, referred to as “GNSS”) represented by, for example, a global positioning system (hereinafter, referred to as “GPS”).

### (Connected State)

A comparative example having a configuration in the related art and a configuration example according to the present embodiment will be described. Here, a configuration for ensuring GND will be described.

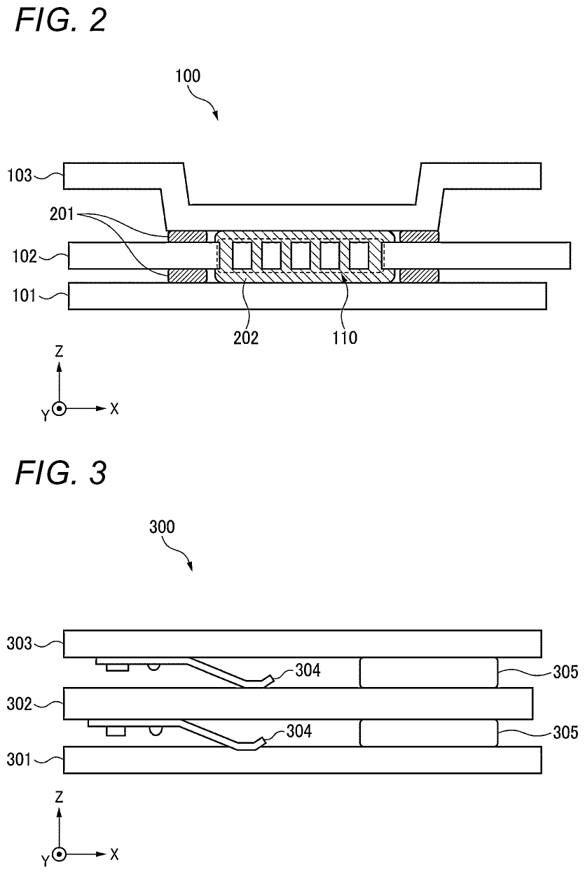

FIG. 2 is a conceptual diagram illustrating a connected state of members shown in FIG. 1 in the onboard device 100 according to the present embodiment. A layer structure composed of the members shown in FIG. 1 is shown in a cross section of an X-Z plane. In the onboard device 100, the LDC 101 and the second metal plate 103 are electrically connected to each other at least partially in order to ensure GND.

FIG. 3 is a conceptual diagram illustrating a connected state of members in an onboard device 300 having the configuration in the related art which is shown as a comparative example. In the onboard device 300, an earth spring is used. Even in the configuration in the related art, in the onboard device 300, an LDC 301 and a second metal plate 303 are electrically connected to each other at least partially in order to ensure GND.

In the onboard device 300 shown in FIG. 3, the LCD 301 and the first metal plate 302 are adhered by a fixing adhesive 305. Further, the first metal plate 302 and the second metal plate 303 are adhered by the fixing adhesive 305. The type and characteristics of the adhesive 305 are not particularly limited, but the adhesive 305 according to the present embodiment has a physical property as an insulator. A conductive earth spring 304 is provided between the LCD 301 and the first metal plate 302, and the LCD 301 and the first metal plate 302 are in electrical communication with each other. Further, the earth spring 304 having conductivity is provided between the first metal plate 302 and the second metal plate 303, and the first metal plate 302 and the second metal plate 303 are in electrical communication with each other. According to this configuration, the LCD 301 and the second metal plate 303 are in electrical communication with each other. In the configuration in the related art, the first metal plate 302 and the second metal plate 303 may be fixed together with screws and the like.

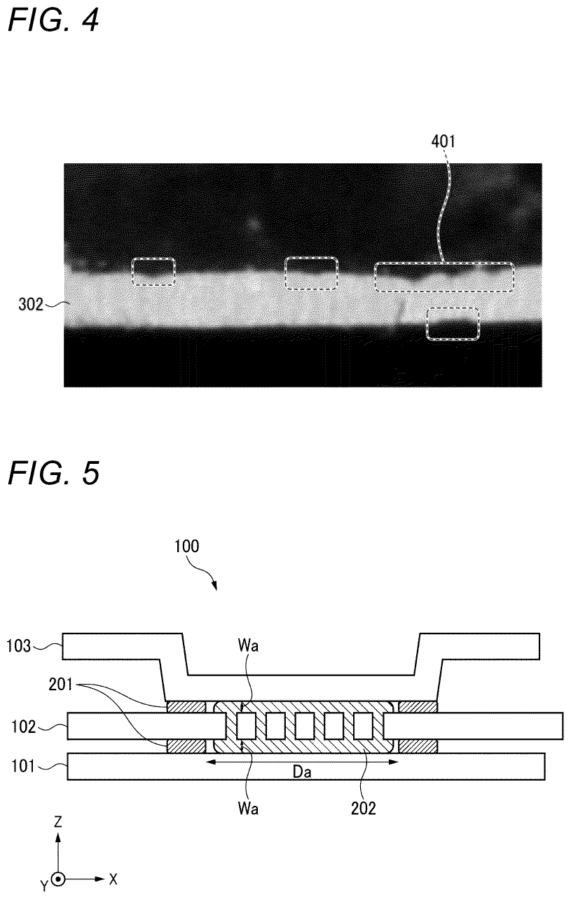

FIG. 4 is a view illustrating unevenness on a surface of the first metal plate 302 and is an enlarged cross-sectional view of the first metal plate 302. As shown in a region 401 indicated by a broken line, the unevenness is formed on the surface of the metal plate due to an influence of a manufacturing process and the like. The unevenness may affect electrical characteristics when in contact with other members. For example, as described above, the presence of bubbles mixed in the unevenness causes a change in electrical resistance.

Quality problems in a configuration using the earth spring include, for example, deformation due to aging, the generation of burrs, and dimensional deviation. In the configuration using the earth spring, the connected state becomes point contact, and the GND performance may not be sufficiently ensured. For example, in FIG. 3, contact between the earth spring 304 and the LCD 301 is point contact, that is, contact in a narrow range, between the LCD 301 and the first metal plate 302.

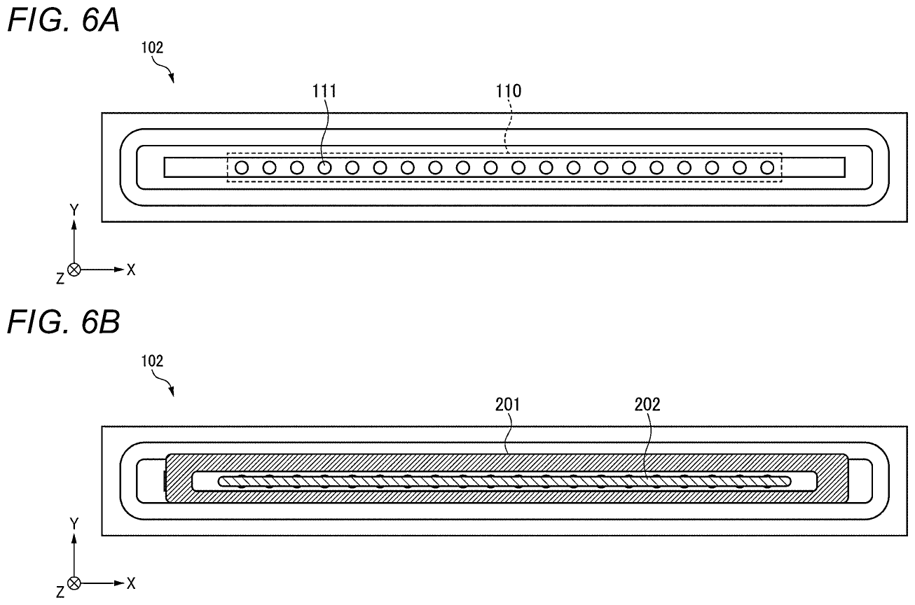

In the present embodiment, as shown in FIG. 2, a conductive adhesive is used instead of the earth spring. Further, through holes are provided in the first metal plate 102 in a region 110 where a conductive adhesive 202 is provided. An example of the through holes will be described later with reference to FIGS. 6A and 6B.

As shown in FIG. 2, the LCD 101 and the first metal plate 102 are adhered and fixed by a fixing adhesive 201. The first metal plate 102 and the second metal plate 103 are adhered and fixed by the fixing adhesive 201. In the present embodiment, the fixing adhesive 201 has the physical property as an insulator. Then, the conductive adhesive 202 is disposed to be surrounded by the fixing adhesive 201. The conductive adhesive 202 is provided to fill the through hole provided in the region 110 of the first metal plate 102. Therefore, the LCD 101 and the second metal plate 103 are electrically connected directly to each other via the conductive adhesive 202. The type and characteristics of the fixing adhesive 201 and the conductive adhesive 202 may be adjusted in accordance with specification required for the onboard device 100.

In the onboard device 100 according to the present embodiment, an application range Da and an application height Wa of the conductive adhesive 202 are defined by predetermined management dimensions in order to ensure the GND performance. FIG. 5 is a conceptual diagram showing the application range Da and the application height Wa of the conductive adhesive 202 according to the present embodiment.

By setting the application range Da and the application height Wa to the predetermined management dimensions, a wide contact area can be ensured rather than the point contact using the earth spring, making it possible to stably ensure the GND performance. In addition, problems such as the deformation, the dimensional deviation, and the generation of burrs that occur when using the earth spring will no longer occur.

Further, in the present embodiment, the application range Da and the application height Wa are defined in consideration of the thermal contraction in a shearing direction (X-axis direction and Y-axis direction) of the conductive adhesive 202. As shown in FIG. 5, a certain clearance (gap) is provided between the fixing adhesive 201 and the conductive adhesive 202 in the application range Da. This is provided in consideration of the physical property related to the thermal contraction of the fixing adhesive 201 and the conductive adhesive 202, which is caused by a temperature change during the operation of the onboard device 100, a use environment, and the like. When the fixing adhesive 201 and the conductive adhesive 202 have different thermal contraction rates, the clearance is defined in accordance with the relationship therebetween so that they do not interfere with each other.

FIGS. 6A and 6B are enlarged views of a periphery of the region 110 of the first metal plate 102. As shown in FIG. 6A, a plurality of through holes 111 are provided in the region 110. The number, shape, and size of the through holes 111 may be defined in accordance with the size and required performance of the onboard device 100. For example, the size of the through hole 111 is defined in accordance with the frequency of the assumed noise. If the size of the through hole 111 is large, there is a tendency that noise easily enters. In order to realize the stability of noise removal, it is desirable that the plurality of through holes 111 have the same size. The shape of the through hole 111 is preferably a circle. For example, in the case where the through hole 111 has a triangular shape, there is a tendency that noise easily enters from a certain direction (for example, an oblique direction).

FIG. 6B is a conceptual diagram when the fixing adhesive 201 and the conductive adhesive 202 are applied to the first metal plate 102. As shown in FIG. 6B, the conductive adhesive 202 is applied to fill the plurality of through holes 111, and the fixing adhesive 201 is applied around the conductive adhesive 202. An application amount of each adhesive is configured to satisfy the management dimensions shown in FIG. 5.

When the conductive adhesive is used, variation in a thickness direction can be absorbed compared to when conductive tape is used. Therefore, for example, the influence of the unevenness on the surface of the first metal plate 102 can be prevented. Since the conductive tape is generally poor in flexibility and a thickness thereof is not easily changed, a degree of absorption of the variation in the thickness direction is small. Therefore, when the conductive tape is used, it is necessary to select tape having a large thickness dimension. As a result, requirements for mounting the onboard device may not be met. For example, when product dimensions of the onboard device become too large, it becomes difficult to mount the onboard device due to interference with or proximity to another adjacent vehicle product. Therefore, components having small dimensions in the thickness direction are required.

In addition, in general, the onboard device has manufacturing characteristics that large-variety and low-volume production is often used compared to other electronic devices. This is due to the fact that corresponding products in the onboard device are different for each vehicle. For these products, it is difficult to manually or automatically perform attachment work of a member such as the conductive tape in a manufacturing facility. For example, automating the attachment of the conductive tape requires equipment such as a robot arm. In contrast, in the case of the adhesive, automatic application work can be performed using an applicator with a relatively simple structure, and the adhesive can be easily adapted to an production environment unique to the onboard device, which is large-variety and low-volume production.

Further, the inclusion of bubbles in the unevenness of the surface of the metal plate as shown in FIG. 4 can be prevented with the adhesive, which is in a liquid state, compared to the conductive tape, which is in a solid state.

### Modification

In the above embodiment, the configuration example has been shown in which, of the first metal plate 102 and the second metal plate 103, a shape around the conductive adhesive 202 is uniformly flat. Further, the shape of each metal plate may be defined in consideration of an external force in the depth direction (Z-axis direction).

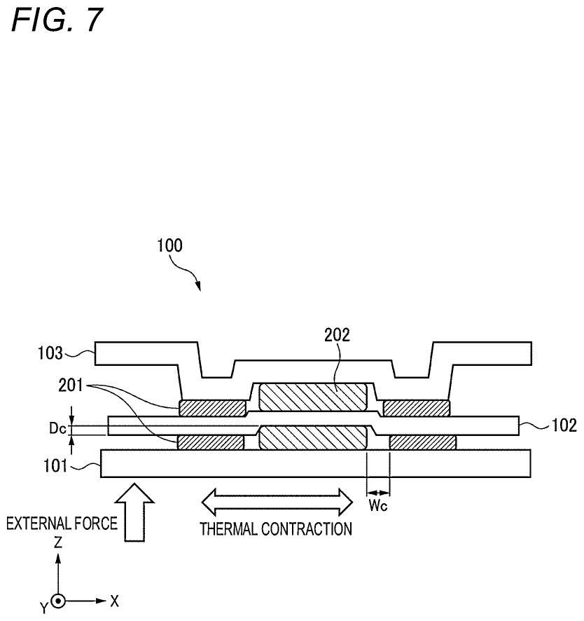

FIG. 7 is a conceptual diagram illustrating a connected state of members in the onboard device 100 as a modification. The layer structure composed of the members shown in FIG. 1 is shown in the cross section of the X-Z plane.

A clearance Dc is a clearance in the Z-axis direction provided on the first metal plate 102. The clearance Dc is formed by a partial drawn shape and the like in the Z-axis direction of the first metal plate 102. By providing the clearance Dc, the external force in the Z-axis direction as shown in FIG. 7 can be concentrated on positions of the fixing adhesives 201. Accordingly, a risk of deterioration in the GND performance due to peeling of the conductive adhesives 202 by the external force can be reduced.

Further, the shape of the first metal plate 102 is configured such that a clearance Wc is provided in consideration of thermal contraction of each adhesive. Accordingly, an influence of the thermal contraction in the X-axis direction as shown in FIG. 7 can be prevented.

As described above, in the onboard device (for example, the onboard device 100) according to the present embodiment, the liquid crystal display (for example, the liquid crystal display 101), the first metal plate (for example, the first metal plate 102), and the second metal plate (for example, the second metal plate 103) are arranged in a layer structure, the liquid crystal display and the first metal plate are connected by the conductive adhesive (for example, the conductive adhesive 202) to ensure GND, the first metal plate and the second metal plate are connected by the conductive adhesive to ensure GND, and the fixing adhesive (for example, the fixing adhesive 201) is disposed around the conductive adhesive. According to the configuration, it is possible to ensure and stabilize the GND performance in the liquid crystal display constituting the onboard device. For example, peeling and falling off of the conductive adhesive can be prevented. It is possible to ensure GND in a wide range and improve the GND performance. As compared with the configuration in which the earth spring is used, it is possible to prevent a quality risk caused by the earth spring, such as deformation and dimensional deviation of the earth spring. Further, there is no need to consider the arrangement of the earth spring or use a fixture, development time and mold construction time can be shortened.

Further, the first metal plate has the plurality of through holes (for example, the through holes 111) in the portion (for example, the region 110) to which the conductive adhesive is applied, and the liquid crystal display and the second metal plate are connected to ensure GND via the conductive adhesive filling the plurality of through holes. According to this configuration, the liquid crystal display and the second metal plate can be electrically and directly connected to each other via the conductive adhesive filled around the plurality of through holes, and it is possible to further ensure GND.

Further, the plurality of through holes are formed in circular shapes having the same dimension. According to this configuration, it is possible to improve the stability related to noise removal.

Further, the first metal plate has the drawn shape (for example, the clearance Dc) in the portion to which the conductive adhesive is applied. According to this configuration, a load caused by the external force is concentrated on the fixing adhesive, and a load on the conductive adhesive portion can be reduced. Therefore, the peeling and the like of the conductive adhesive can be prevented.

Further, a gap (for example, the clearance Wc) is formed between the conductive adhesive and the fixing adhesive and between the liquid crystal display and the first metal plate. A gap is formed between the conductive adhesive and the fixing adhesive and between the first metal plate and the second metal plate. The gap is defined based on a physical property of thermal contraction of the conductive adhesive and the fixing adhesive. According to this configuration, by providing the clearance in consideration of the physical property related to the thermal contraction of the conductive adhesive and the fixing adhesive, it is possible to prevent interference and contact caused by the expansion of the conductive adhesive and the fixing adhesive due to a temperature change.

Although various embodiments have been described above with reference to the drawings, it is needless to say that the present disclosure is not limited to such examples. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the various embodiments described above may be combined freely in a range without deviating from the spirit of the disclosure.

### Note

The following techniques are disclosed based on the above description of the embodiments.

### Technique 1

An onboard device includes: a liquid crystal display; a first metal plate; and a second metal plate, which are arranged in a layer structure. The liquid crystal display and the first metal plate are connected by a conductive adhesive to ensure GND. The first metal plate and the second metal plate are connected by the conductive adhesive to ensure the GND. A fixing adhesive is disposed around the conductive adhesive.

According to this configuration, it is possible to ensure and stabilize the GND performance in the liquid crystal display constituting the onboard device. For example, the peeling and falling off of the conductive adhesive can be prevented. Further, it is possible to ensure GND in the wide range and improve the GND performance. As compared with the configuration in which the earth spring is used, it is possible to prevent the quality risk caused by the earth spring, such as deformation and dimensional deviation of the earth spring. Further, there is no need to consider the arrangement of the earth spring or use the fixture, the development time and the mold construction time can be shortened.

### Technique 2

In the onboard device according to the Technique 1, the first metal plate has a plurality of through holes in a portion to which the conductive adhesive is applied. The liquid crystal display and the second metal plate are connected to ensure the GND via the conductive adhesive filling the plurality of through holes.

According to this configuration, the liquid crystal display and the second metal plate can be electrically and directly connected to each other via the conductive adhesive filled around the plurality of through holes, and it is possible to further ensure GND.

### Technique 3

In the onboard device according to the Technique 2, the plurality of through holes are formed in circular shapes having the same dimension.

According to this configuration, it is possible to improve the stability related to the noise removal.

### Technique 4

In the onboard device according to any one of the Techniques 1 to 3, the first metal plate has a drawn shape in a portion to which the conductive adhesive is applied.

According to this configuration, the load caused by the external force is concentrated on the fixing adhesive, and the load on the conductive adhesive portion can be reduced. Therefore, the peeling and the like of the conductive adhesive can be prevented.

### Technique 5

In the onboard device according to any one of the Techniques 1 to 4, a gap is formed between the conductive adhesive and the fixing adhesive and between the liquid crystal display and the first metal plate.

According to this configuration, it is possible to prevent interference and contact caused by the expansion of the conductive adhesive and the fixing adhesive due to the temperature change. Therefore, the peeling and the like of the conductive adhesive can be prevented, and the GND performance can be stabilized.

### Technique 6

In the onboard device according to any one of the Techniques 1 to 5, a gap is formed between the conductive adhesive and the fixing adhesive and between the first metal plate and the second metal plate.

According to this configuration, it is possible to prevent the interference and contact caused by the expansion of the conductive adhesive and the fixing adhesive due to the temperature change. Therefore, the peeling and the like of the conductive adhesive can be prevented, and the GND performance can be stabilized.

### Technique 7

In the onboard device according to the Technique 5 or 6, the gap is defined based on a physical property of thermal contraction of the conductive adhesive and the fixing adhesive.

According to this configuration, by providing the clearance in consideration of the physical property related to the thermal contraction of the conductive adhesive and the fixing adhesive, it is possible to prevent the interference and contact caused by the expansion of the conductive adhesive and the fixing adhesive due to the temperature change.

The present disclosure is useful, for example, as an onboard device including a liquid crystal display, but is not limited.

What is claimed is:

1. An onboard device comprising:
a liquid crystal display; a first metal plate; and a second metal plate, which are arranged in a layer structure, wherein
the liquid crystal display and the first metal plate are connected by a conductive adhesive to ensure GND,
the first metal plate and the second metal plate are connected by the conductive adhesive to ensure the GND, and
a fixing adhesive is disposed around the conductive adhesive.

2. The onboard device according to claim 1, wherein
the first metal plate has a plurality of through holes in a portion to which the conductive adhesive is applied, and
the liquid crystal display and the second metal plate are connected to ensure the GND via the conductive adhesive filling the plurality of through holes.

3. The onboard device according to claim 2, wherein
the plurality of through holes are formed in circular shapes having the same dimension.

4. The onboard device according to claim 1, wherein
the first metal plate has a drawn shape in a portion to which the conductive adhesive is applied.

5. The onboard device according to claim 1, wherein
a gap is formed between the conductive adhesive and the fixing adhesive and between the liquid crystal display and the first metal plate.

6. The onboard device according to claim 5, wherein
the gap is defined based on a physical property of thermal contraction of the conductive adhesive and the fixing adhesive.

7. The onboard device according to claim 1, wherein
a gap is formed between the conductive adhesive and the fixing adhesive and between the first metal plate and the second metal plate.

8. The onboard device according to claim 7, wherein
the gap is defined based on a physical property of thermal contraction of the conductive adhesive and the fixing adhesive.
